(19) United States
(12) Patent Application Publication
(10) Pub. No.: US 2003/0117288 A1
(43) Pub. Date: Jun. 26, 2003

(54) Illuminance detection alarm device

(76) Inventor: Tung-Liang Li, Taichung (TW)

Correspondence Address: Tung-Liang Li, 58, MA YUAN WEST ST., TAICHUNG, TW

(21) Appl. No.: 10/028,179

(22) Filed: Dec. 21, 2001

(51) Int. Cl. G08B 17/12

(52) U.S. Cl. 340/600; 340/641

(57) ABSTRACT

The present invention relates to an illuminance detection alarm device including a main body, an illuminance sensing head, a power switch, a buzzer switch, an indication lamp unit, and an alarm range setting switch. The illuminance sensing head may detect the illuminance of light of the surroundings. The indication lamp unit includes a green indication lamp, a red indication lamp and a yellow indication lamp. The alarm range setting switch may be used to set multiple stages of different alarm ranges according to the practical requirements of the user. Thus, the reader may notice the illuminance of light of the surroundings, so as to obtain a better illumination effect, thereby preventing the reader from being short-sighted due to the bad illumination surroundings.

### BACKGROUND OF THE INVENTION

1. Field of the Invention

The present invention relates to an illuminance detection alarm device, and more particularly to an illuminance detection alarm device that may be operated easily, and may detect the illuminance of light exactly.

2. Description of the Related Art

Usually, when a person is located in a dark place, the lamp may provide an illumination effect to the dark place, so that the user may read or work conveniently. Thus, the illuminance of light of the lamp is very important to the user. In general, the illuminance of light of the reading room may be set at 400 lux, the illuminance of light of the working factory may be set at 700 lux, and the illuminance of light of the computer typewriter may be set at 1000 lux. If the lamp cannot provide sufficient illuminance of light to the user, the user is easily short-sighted or tired.

### SUMMARY OF THE INVENTION

The primary objective of the present invention is to provide an illuminance detection alarm device that may be operated easily, and may detect the illuminance of light exactly.

Another objective of the present invention is to provide an illuminance detection alarm device, wherein by the illuminance detection alarm device 1, the reader may notice the illuminance of light of the surroundings, so as to obtain a better illumination effect, thereby preventing the reader from being short-sighted due to the bad illumination surroundings.

A further objective of the present invention is to provide an illuminance detection alarm device, wherein the alarm range setting switch may adjust and set multiple stages of different alarm ranges according to the practical requirements of the user, thereby enhancing the versatility of the illuminance detection alarm device 1. For example, the illuminance of the reading room may be set at 400 lux, the illuminance of the working factory may be set at 700 lux, and the illuminance of the computer typewriter may be set at 1000 lux.

In accordance with the present invention, there is provided an illuminance detection alarm device, comprising: a main body, an illuminance sensing head, a power switch, a buzzer switch, an indication lamp unit, and an alarm range setting switch, wherein:

the main body is portable such that the user may take the main body easily and conveniently, the illuminance sensing head may be used to detect the illuminance of the light of the surroundings, and includes a signal amplifying and processing device for transmitting the detected light signal to the alarm range setting switch, the power switch may be used to turn on and turn off the electric power of the illuminance detection alarm device, the buzzer switch may be used to turn on and turn off the buzzing function of the buzzer, the indication lamp unit includes a green indication lamp, a red indication lamp and a yellow indication lamp, and the alarm range setting switch may be used to set multiple stages of different alarm ranges according to the practical requirements of the user.

Thus, when the green indication lamp lights, it indicates that the power supply is disposed at a normal state. When the red indication lamp lights, it indicates that the illuminance of the reading surroundings is smaller than the set value. When the yellow indication lamp lights, it indicates that the low power detection circuit detects that the voltage of the battery is lower than the voltage required by the illuminance detection alarm device.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an illuminance detection alarm device in accordance with a preferred embodiment of the present invention;

FIG. 2 is a bottom perspective view of an illuminance detection alarm device in accordance with a preferred embodiment of the present invention; and

FIG. 3 is an operation block view of an illuminance detection alarm device in accordance with a preferred embodiment of the present invention.

### DETAILED DESCRIPTION OF THE INVENTION

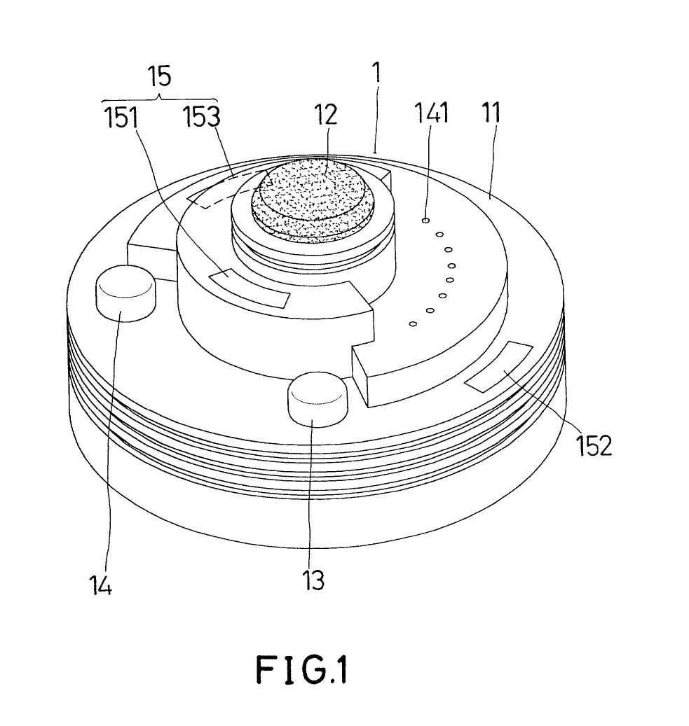

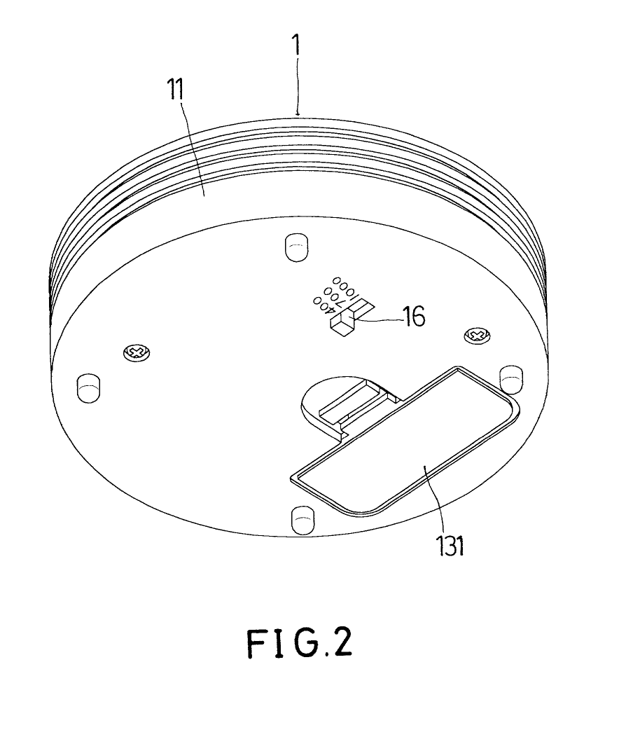

Referring to the drawings and initially to FIGS. 1 and 2, an illuminance detection alarm device 1 in accordance with a preferred embodiment of the present invention comprises a main body 11, an illuminance sensing head 12, a power switch 13, a buzzer switch 14, an indication lamp unit 15, and an alarm range setting switch 16.

The main body 11 is portable such that the user may take the main body 11 easily and conveniently.

The illuminance sensing head 12 may be used to detect the illuminance of the light of the surroundings, and includes a signal amplifying and processing device 121 for transmitting the detected light signal to the alarm range setting switch 16.

The power switch 13 may be used to turn on and turn off the electric power 131 of the illuminance detection alarm device 1.

The buzzer switch 14 may be used to turn on and turn off the buzzing function of the buzzer 141.

The indication lamp unit 15 includes a green indication lamp 151, a red indication lamp 152 and a yellow indication lamp 153. When the green indication lamp 151 lights, it indicates that the power supply is disposed at a normal state. When the red indication lamp 152 lights, it indicates that the illuminance of the reading surroundings is smaller than the set value. When the yellow indication lamp 153 lights, it indicates that the low power detection circuit 154 detects that the voltage of the battery is lower than the voltage required by the illuminance detection alarm device 1.

The alarm range setting switch 16 may be used to set multiple stages of different alarm ranges according to the practical requirements of the user, such as 400 lux, 700 lux and 1000 lux.

Thus, by the illuminance detection alarm device 1 in accordance with the present invention, the reader may notice the illuminance of light of the surroundings, so as to obtain a better illumination effect, thereby preventing the reader from being short-sighted due to the bad illumination surroundings.

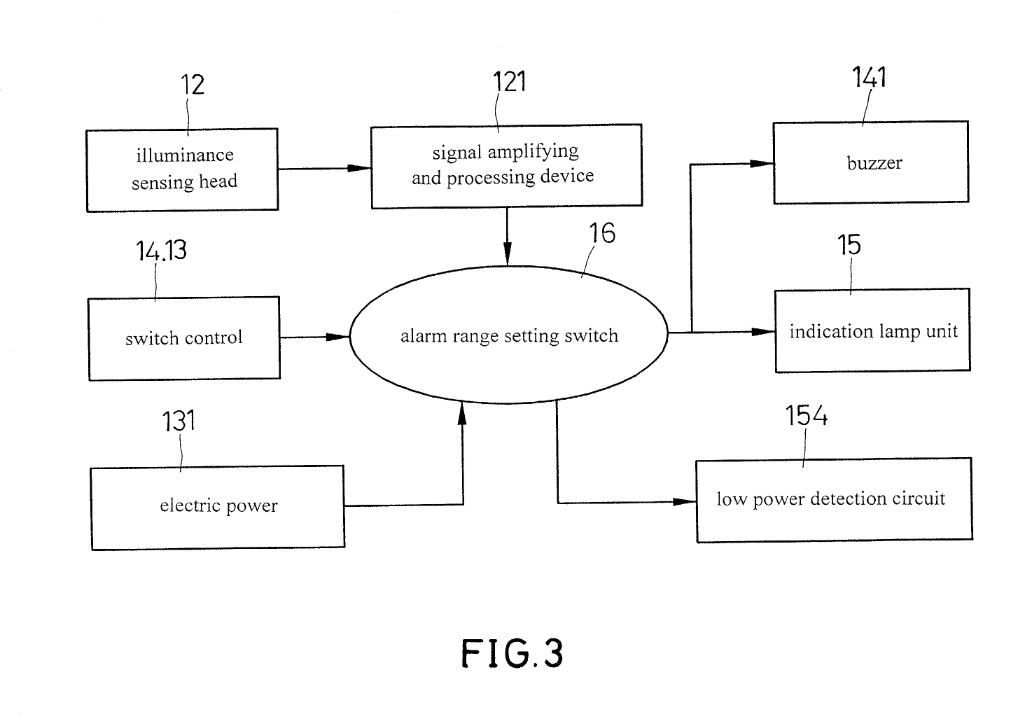

In operation of the illuminance detection alarm device 1 in accordance with the present invention, referring to FIG. 3 with reference to FIGS. 1 and 2, the illuminance detection alarm device 1 may be placed on the place to be warned, such as the reading room or the office under the lamp. Then, the alarm range setting switch 16 under the main body 11 may be adjusted to a set value. For example, the illuminance of the reading room may be set at 400 lux, the illuminance of the working factory may be set at 700 lux, and the illuminance of the computer typewriter may be set at 1000 lux. Then, the power switch 13 may be pressed to turn on the electric power 131 of the illuminance detection alarm device 1.

When the green indication lamp 151 lights, it indicates that the power supply is disposed at a normal state. Then, the buzzer switch 14 may be pressed, so as to proceed operation of detection of the illuminance. When the red indication lamp 152 lights, it indicates that the illuminance of the reading surroundings is lower than the set value. Thus, the buzzer 141 will buzz, thereby providing a warning effect. When the yellow indication lamp 153 lights, it indicates that the low power detection circuit 154 detects that the voltage of the battery is lower than the voltage required by the illuminance detection alarm device 1. If the detected illuminance value satisfies the set value, the buzzer 141 will not buzz. Then, the power switch 13 may be pressed to turn off the electric power 131 of the illuminance detection alarm device 1.

Accordingly, the illuminance detection alarm device 1 in accordance with the present invention has the following advantages.

1. The illuminance detection alarm device 1 may be operated easily, and may detect the illuminance of light exactly.

2. By the illuminance detection alarm device 1, the reader may notice the illuminance of light of the surroundings, so as to obtain a better illumination effect, thereby preventing the reader from being short-sighted due to the bad illumination surroundings.

3. The alarm range setting switch 16 may adjust and set multiple stages of different alarm ranges according to the practical requirements of the user, thereby enhancing the versatility of the illuminance detection alarm device 1. For example, the illuminance of the reading room may be set at 400 lux, the illuminance of the working factory may be set at 700 lux, and the illuminance of the computer typewriter may be set at 1000 lux.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An illuminance detection alarm device, comprising: a main body, an illuminance sensing head, a power switch, a buzzer switch, an indication lamp unit, and an alarm range setting switch, wherein:
the main body is portable such that the user may take the main body easily and conveniently, the illuminance sensing head may be used to detect the illuminance of the light of the surroundings, and includes a signal amplifying and processing device for transmitting the detected light signal to the alarm range setting switch, the power switch may be used to turn on and turn off the electric power of the illuminance detection alarm device, the buzzer switch may be used to turn on and turn off the buzzing function of the buzzer, the indication lamp unit includes a green indication lamp, a red indication lamp and a yellow indication lamp, and the alarm range setting switch may be used to set multiple stages of different alarm ranges according to the practical requirements of the user.

2. The illuminance detection alarm device in accordance with claim 1, wherein when the green indication lamp lights, it indicates that the power supply is disposed at a normal state.

3. The illuminance detection alarm device in accordance with claim 1, wherein when the red indication lamp lights, it indicates that the illuminance of the reading surroundings is smaller than the set value.

4. The illuminance detection alarm device in accordance with claim 1, wherein when the yellow indication lamp lights, it indicates that the low power detection circuit detects that the voltage of the battery is lower than the voltage required by the illuminance detection alarm device.
